(19) United States
(12) Patent Application Publication
(10) Pub. No.: US 2008/0231524 A1
(43) Pub. Date: Sep. 25, 2008

(54) EAR MOUNTED COMMUNICATION DEVICES AND METHODS

(75) Inventors: DAVID R. ZEIGER, Mundelein, IL (US); Rachid M. Alameh, Crystal Lake, IL (US); Thomas J. Walczak, Woodstock, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/690,397

(22) Filed: Mar. 23, 2007

(51) Int. Cl. H01Q 1/12

(52) U.S. Cl. 343/718

(57) ABSTRACT

Disclosed is a wireless communication device including a housing and an earmount attached to the housing. A wireless transceiver is supported by the housing, the wireless transceiver being configured to communicate with a cellular base station. A power source supported by the housing can be coupled to the wireless transceiver, the power source having sufficient energy to power the wireless transceiver for communication with the cellular base station. The earmount is attached to the housing at a portion proximate to the power source. An antenna supported by the housing is coupled to the wireless transceiver, the antenna being configured to propagate wave energy primarily in a direction about the power source.

### FIELD

Disclosed are devices and methods of a wearable electronic device, and more particularly, devices and methods of an earmounted wireless communication device.

### BACKGROUND

The makers of mobile communication devices, including those of cellular telephones, are increasingly adding functionality to their devices. While there is a trend toward the inclusion of more features and improvements for current features, there is also a trend toward smaller mobile communication devices. As mobile communication device technology has continued to improve, the devices have become increasingly smaller. Therefore, there may be less surface area for placement of user interface components as manufacturers continue to add features and reduce their products' size.

Cellular telephones typically have a handset form factor configured so that a user holds the device to the ear while it is engaged in operation. A hands-free device, such as a headset that is either in wireless or wired communication with a cellular phone can free a user from the need to hold a handset form factor cellular phone to his or her ear. A wireless hands-free device may employ a short range communication protocol such as Bluetooth to transmit data such as voice data to a paired cellular communication device and receive data from a paired cellular communication device. Some users may find it cumbersome to operate two devices including the handheld device and the hands-free device simultaneously. In particular, a headset device is limited in functionally due to limited surface area and therefore simply acts as a functional conduit to the handheld device.

A benefit of the use of a headset is that a cellular antenna is maintained at the user's head in the paired cellular communication device or other handheld device Positioning of an antenna or phone body (which can be a part of the antenna) near the user's head may detune the antenna and may thus adversely affect the performance of wireless communication by the handset. Moreover, in a handheld device an antenna may be placed at the end of the housing supporting the keypad. However, since a user's hand will cover the device as it is held up to the user's head, the amount of power used to drive the cellular antenna must compensate for the fact that a hand is covering the antenna.

### BRIEF DESCRIPTION OF THE DRAWINGS

FIG. 1 depicts a view of an embodiment of an electronic device and that may be wireless communication device such as a cellular telephone;

FIG. 2 depicts a second view of an embodiment of the electronic device of FIG. 1;

FIG. 3 depicts a third view of an embodiment of an electronic device;

FIG. 4 is a block diagram depicting components of the wearable cellular telephone device;

FIG. 5 is a schematic diagram of the device illustrating the position of the power source and the antenna of the device with respect to the earmount;

FIG. 6 depicts an embodiment of a wearable cellular device where the label on the housing is removed, revealing an antenna element;

FIG. 7 depicts an embodiment of a wearable cellular device where the top cover of the housing is removed;

FIG. 8 depicts an embodiment of the top side of the housing of the wearable wireless communication device;

FIG. 9 illustrates an embodiment of a button contact that may be activated when the user depresses the sensing area as illustrated in FIG. 8;

FIG. 10 depicts an embodiment of a microphone boom including a microphone;

FIG. 11 depicts a perspective view of the microphone boom including microphone;

FIG. 12 depicts a side view of the retractable boom as it may be positioned on a housing;

FIG. 13 depicts a metal top of a SIM card connector that may be used as part of the antenna tuning system;

FIG. 14 depicts an embodiment of a bottom side of the housing;

FIG. 15 depicts an end view of a device;

FIG. 16 depicts a perspective view of a device;

FIG. 17 is a cut away view of the device depicting an arrangement for a SIM card holder;

FIG. 18 depicts an embodiment of a device having the top portion of the housing removed to expose an embodiment of an antenna configuration;

FIG. 19 depicts an embodiment of an indicator light scheme;

FIG. 20 is an embodiment of the top of a printed circuit board that may include shielding;

FIG. 21 is an embodiment of the bottom of a printed circuit board that may include shielding;

FIG. 22 depicts an earmounted cellular telephone device and a handset form factor frame; and

FIG. 23 is a flow chart depicting a method of the above-described earmounted cellular telephone device that may receive communication signals via a cellular transceiver and transmit communication signals via the cellular transceiver.

### DETAILED DESCRIPTION

Disclosed is a wireless communication device capable of being positioned in a wearable position adjacent a user's head. The disclosed wireless communication device includes a wireless transceiver supported by the housing, the wireless transceiver being configured to communicate with a cellular base station. The wireless communication device may include a housing and an earmount coupled to the housing. The earmount can have any suitable shape, including an arcuate shape of an earhook or an earloop. In this way, the earmount can make a wireless communication device, such as a cellular telephone or a headset, an over-the-ear device that can be convenient to use.

The earmount may be configured so that it includes an overhanging, lower, or extended portion and a hinge portion, the hinge portion coupling the earmount to the housing. The overhanging portion of the earmount may be convenient for a user to find and thus may facilitate situating the device over the ear. The overhanging portion may hang over the user's ear when positioned adjacent a user's head, and over the user's ear. The overhanging portion of the earmount may be stable, even when touched by the user because of the manner in which it may hang down from the ear from which it is balanced.

In an ear mounted cellular device, there is a limited volume in which to position a cellular antenna. A cellular antenna may require more space or volume in a housing than a short range antenna, such as a Bluetooth antenna. The size and in particular the disclosed arrangements and configurations of components of the ear mounted cellular telephone device may allow the device to have a configuration similar to that of a short-range headset, such as a Bluetooth headset, while supporting a cellular antenna. In this way, a user may have the hands-free benefit of a headset without the inconvenience of pairing the devices and the inconvenience of operating two devices simultaneously.

Disclosed is a wireless communication device including a housing and an earmount attached to the housing. A wireless cellular transceiver is supported by the housing, the wireless transceiver being configured to communicate with a cellular base station. A power source supported by the housing can be coupled to the wireless transceiver, the power source having sufficient energy to power the wireless transceiver for communication with the cellular base station. The earmount is attached to the housing at a portion proximal the power source. An antenna supported by the housing is coupled to the wireless transceiver, the antenna being configured to propagate wave energy primarily in a direction about the power source.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

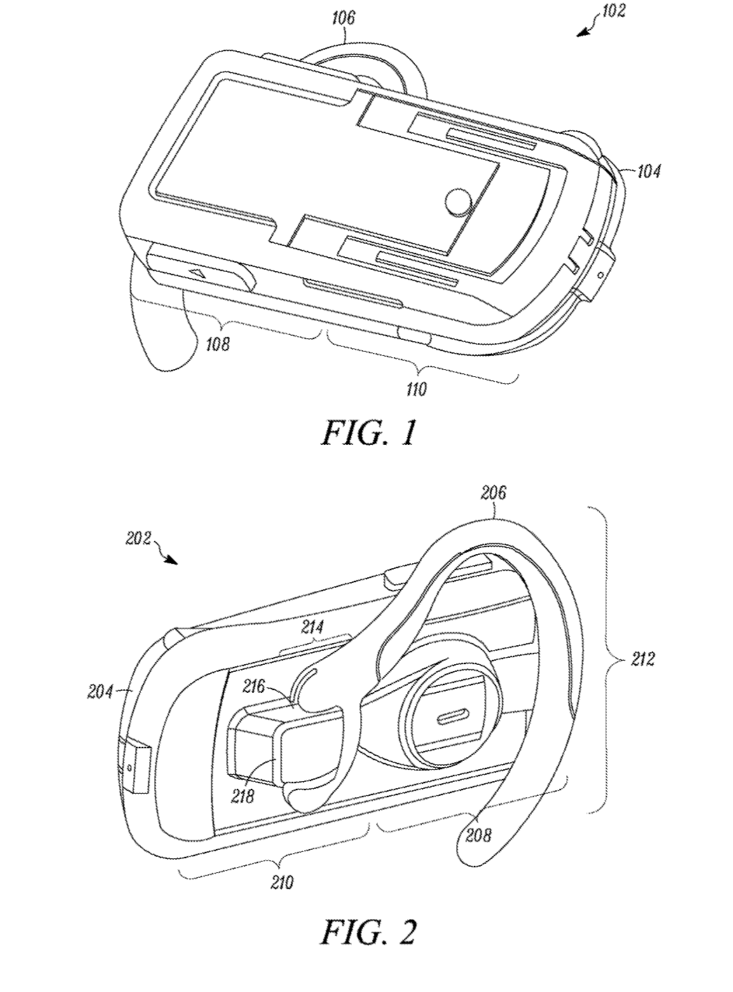

FIG. 1 depicts a view of an embodiment of an electronic device 102 that may be a wireless communication device such as a cellular telephone. The device 102 can include electronic components that are supported by a housing 104. An earmount 106 may be disposed proximal the housing 104 at a position such as within housing portion 108. The earmount 106, for example, may have a hook shape such as that depicted in FIG. 1 or for example, may have a loop shape. In either case, the earmount 106 may have an arcuate shape adapted to conform to the shape of a user's ear.

It is understood that any suitable shape of the earmount 106 is within the scope of this discussion. The earmount 106 may be more or less curved than that shown in the drawings. It may be thinner or thicker than that shown in the drawings. It may be longer or shorter than that shown in the drawings. It may have more gradient between one end to the other end, or less gradient between ends than that shown in the drawings. It may be rotatably and/or detachably and/or pivotably mounted to the housing 104, or may be fixably mounted to the housing 104. It is understood that ergonomic considerations are considered within the scope of this discussion and it is understood that any earmount 106 shape, composition, weight, texture and attachment are within the scope of this discussion. For example, an earmount attachment point of the housing may be a rotatable attachment point so that once the device is placed on a user's ear, the earmount may swivel enough to alleviate pressure on the ear, while still maintaining a secure position. Any manner in which the earmount is adapted to conform to the shape of a user's ear, or adapted to the shape of a user's ear, is within the scope of this discussion. For example, the earmount 106 may be conformable behind a user's ear, so that the wearable electronic device may be fit more precisely to a particular user's ear canal. Furthermore, the earmount 106 may include electronic components and the attachment device may include electrical contacts. The earmount 106 may be coupled in any manner to the housing 104 within housing portion 110.

It is understood that the wearable electronic device 102 may be implemented as a wireless communication device such as a cellular telephone (also called a mobile phone) or a headset or other type of ear worn device. The mobile communication device 102 represents a wide variety of devices that have been developed for use within various networks. Such communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

It is further understood, that any type of functionality may be incorporated as part of the device 102. As mentioned above, the makers of mobile communication devices, including those of cellular telephones, are increasingly adding functionality to their devices. For example, cellular telephones include features such as still and video cameras, video streaming and two-way video calling, email functionality, Internet browsers, music players such as MP3 players, AM and/or FM radios with mono or stereo audio, and organizers. For video streaming, a folding display may be incorporated onto the housing 104 so that when the device 102 is worn, the display screen is folded in next to the housing 104.

Short-range enabled cellular telephones, such as Bluetooth phones, may be PC compatible so that files generated or captured on the mobile communication device may be downloaded to a PC. Likewise, data from a PC or other source may be uploaded to the mobile communication device. Cellular telephones in particular are becoming more than simply mobile communication devices. They are evolving into powerful tools for information management.

Mobile commerce (M-commerce) is yet another functionality being incorporated into the operations of mobile communication devices. Mobile commerce refers to transactions using a wireless device and data connection that result in the transfer of value in exchange for information, services, or goods. Near field protocols such as Bluetooth, radio frequency identification (RFID), personal area network (PAN), as well as Internet capabilities can enable mobile communication devices such as cellular telephones to carry out financial transactions. Mobile commerce, facilitated generally by mobile phones, can include services such as banking, payment, and ticketing. Accordingly, mobile communication devices may replace traditional wallets and credit cards. The emerging technology behind m-commerce may transform the mobile communication device into an electronic wallet. It is understood that a device 102 may support any functionality and may include any number of transceivers for communication in addition to the described cellular transceiver.

FIG. 2 depicts a second view of an embodiment of an electronic device 202. The depicted earmount 206 may include an overhanging portion 212 and a hinge portion 214. The hinge portion 214 may include a hinge component 216 that may couple the earmount 206 to the housing 204 within housing portion 210 that may contain hinge components 218 configured to mate with the earmount hinge portion 214. In another embodiment, the hinge component 216 may rotatably and/or detachably couple the earmount 206 to the housing 204 within housing portion 210 that may contain one or more hinge components 218. Upon rotation and/or detachment, the earmount hinge component 216 may be configured to change the orientation of the earmount 206 from a first orientation with respect the housing 204, such as the orientation depicted, to a second orientation with respect to the housing 204, which may be a mirror reflection of the depicted orientation. Accordingly, the device 202 may be worn on either side of a user's head. The housing hinge component 218 that is coupled to the housing 204 within housing portion 210 may contain circuitry to direct signals received from electronic components of the earmount 206 to a controller that may be supported by the device housing 204.

The overhanging portion 212 may hang over the user's ear when positioned adjacent a user's head, and over the user's ear. The overhanging portion 212 of the earmount 106 may be stable, even when touched by the user because of the manner it which it may hang down from the ear from which it is balanced. The point or points at which the earmount 206 can positioned on the top portion of a user's ear may be proximal housing portion 208. The earmount 206 may form an angle with the housing 204, and thus may provide added tension to press the device to the user's ear.

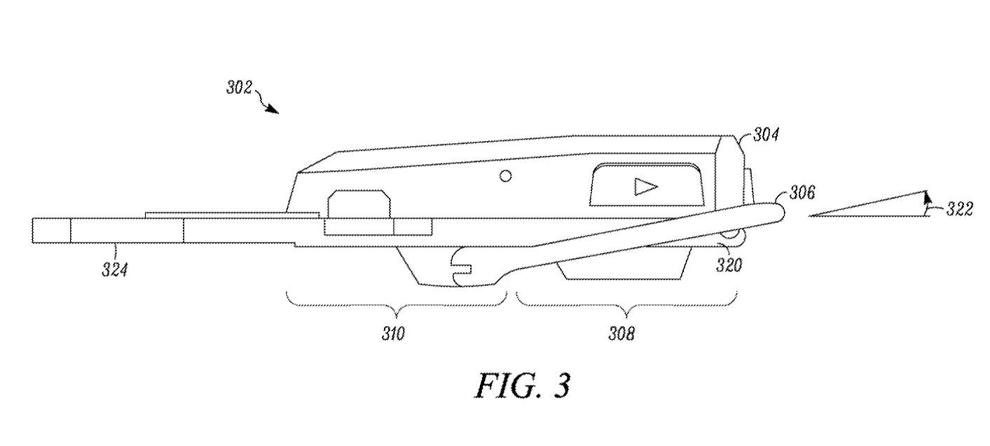

FIG. 3 depicts a view of an embodiment of an electronic device 302. As discussed above, the earmount 306 may be attached to the housing 304 within housing portion 310 so that the earmount 306 is proximal housing portion 308. The earmount 306 may form an angle with a side 320 of the housing 304 of the device 302. The angle may be a predetermined angle oblique to (or from) the housing 304. Such an angle 322, for example approximately 15°, may provide some tension to hold the device 302 against a user's ear, benefiting the user by making the device 302 more comfortable to wear. Also depicted in FIG. 3 is a retractable boom 324 retractably coupled to the housing 304. The boom 324 is discussed below.

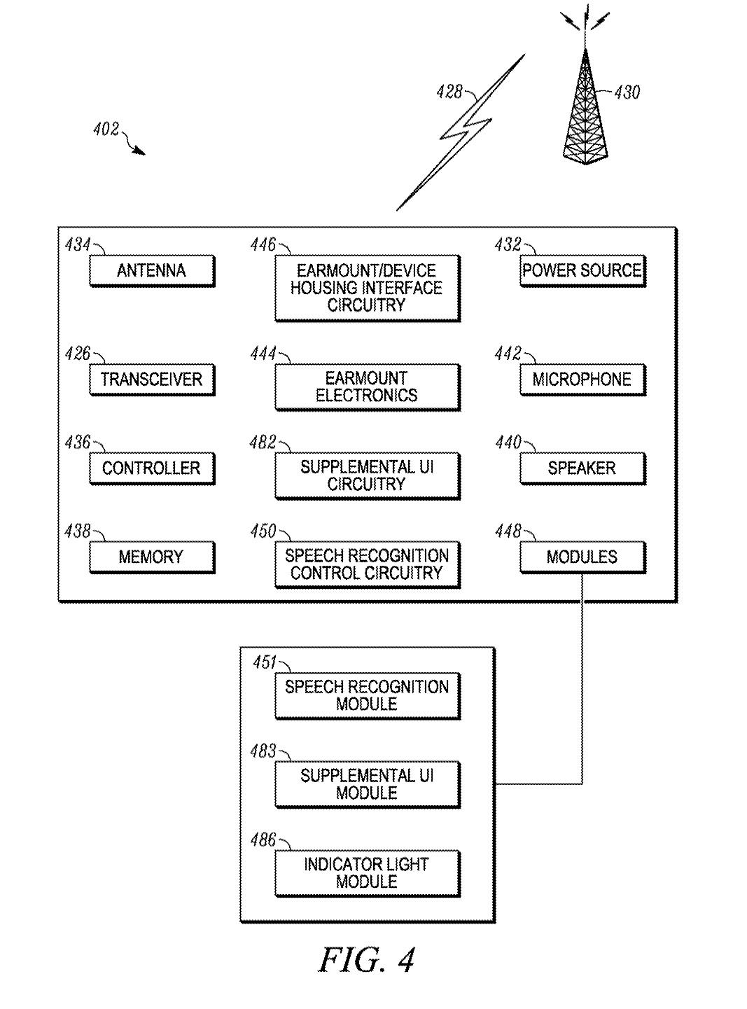

FIG. 4 is a block diagram depicting components of the wearable cellular telephone device 402. As mentioned above, there may less surface area for placement of user interface components on the housing 204 (see FIG. 2) to accommodate adding features with a reduced products size. The configuration and arrangement of components, and in particular the cellular antenna, as will be discussed in more detail below, may possibly optimize the functionality of the device 202 even though there may a limited surface area based on the preferred small size of the housing 204.

The device can include a wireless transceiver 426 supported by the housing 204 (see FIG. 2), the wireless transceiver 426 being configured to communicate 428 with a cellular base station 430. As mentioned, the device 402 may include any number of transceivers. A power source 432 can be coupled to the wireless transceiver 426 and supported by the housing 204, the power source 432 having sufficient energy to power the wireless transceiver 426 for communication with the cellular base station 430. An antenna 434 can be coupled to the wireless transceiver 426 and supported by the housing 204, the antenna 434 being configured to propagate wave energy primarily in a direction about the power source 432, and in an embodiment, avoiding the propagation of wave energy through the power source 432. An earmount 206 may be attached to the housing 204 at a portion proximal the power source 432.

Other components, that will be discussed below include a controller 436 memory 438, a speaker 440, a microphone 442, earmount electronics 444, and circuitry between the earmount 206 (see FIG. 2) and the device housing 204, that is, earmount/device housing interface circuitry 446. As mentioned above, the one or more housing hinge components 218 that is coupled to the housing 204 within housing portion 210 may contain circuitry to direct signals received from electronic components of the earmount 206 to the controller 436 that may be supported by the device housing 204. The circuitry 446 between the earmount 206 and the device housing 204 may support the electronic components of the earmount 206.

Modules 448 may include instructions for a voice or speech recognition module 451, a tactile controls or supplemental user interface (UI) module 483 and an indicator light module 486. The modules may carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

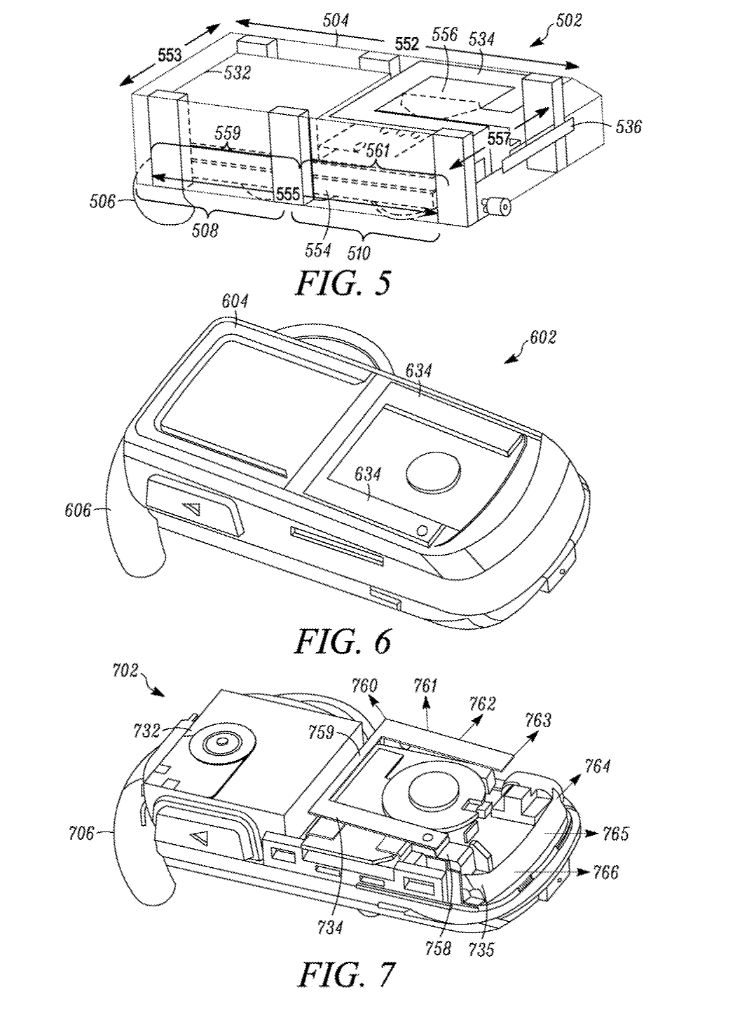

FIG. 5 is a cutaway view of the device illustrating the position of the power source 532 and the antenna 534 of the device 502 with respect to the earmount 506. The power source 532 may have sufficient energy to power the wireless transceiver 426 (see FIG. 4) for communication with the cellular base station 430. In keeping with industry practices for stand-by hours and talk hours, a power source 532 may be large with respect to the size of the device 502 in order to adequately power the cellular transceiver 426 and/or other applications of the device. For example, the power source 532 of the device 502 may have a “low impedance” to support high peak current and may be, thus, capable of driving a cellular pulse, such as a GSM pulse of about 1.7 A. At the same time, the power source 532 may maintain a higher milli-amp-hour (mAh) capacity for adequate talk time, such as 2 or more hours of talk time. Also, by example, the mAh capacity of the power source 532 may be much greater than that of a short-range headset and less than or equal to that of a cellular handset. As improvements are made to power sources, they may be better able to store more energy that may last for longer durations of time, and/or they may have a reduced size having the same energy storage capability.

As mentioned above, an earmount 506 can be coupled to the housing 504 at a position such as within housing portion 508, for example, by a hinge. The point or points at which the earmount 506 can be positioned on the top portion of a user's ear may be proximal housing portion 508 and/or to housing portion 510. Accordingly, the power source 532 may have a weight sufficient so that it may offset a majority of the torque forces of the device 502 when the device 502 is supported by the earmount 506, possibly providing comfort of the device 502 when worn by the user. The offset of a majority of the torque forces of the device 502 as just described may make the overhanging portion (see 212, FIG. 2) of the earmount 506 stable, even when touched by the user. The stability may arise from the manner in which the overhanging portion 212 may hang down from the ear from which it is balanced. The stability may also stem from the weight of the power source 532 and its relative position with respect to the earmount 506 and the other components of the device 502. Moreover, the weight distribution of the device may be centered at the earmount which may increase its comfort to the user.

In one embodiment, the housing 504 has a length 552 and a width 553, the length 552 defining a first portion 508 of the housing 504 having a first size and a second portion 510 of the housing 504 having a second size and wherein the power source 532 may occupy a volume of the first portion 508 of the housing 504. The first size of the first portion 508 may be approximately equal to the second size of the second portion 510. In another embodiment, the housing 504 includes a volume and the power source 532 may occupy a majority of the volume of the housing 504. In another embodiment, an antenna 534 may be positioned in a portion 510 of the volume outside the majority of the volume 508 occupied by the power source 532. In another embodiment, an antenna 534 may be supported by the housing 504 and positioned within a second portion 510 of the internal volume of the housing 504. In yet another embodiment, the power source 532 may occupy a volume of the housing 504 so that the weight distribution of the volume of the housing is predominantly adjacent the earmount 506. In the described embodiments, the power source 532 can be positioned at one end of the housing 504 while the antenna 534 may be situated at the other end of the housing 504. In another embodiment, the antenna 534 may be positioned in a portion of the volume of the housing 504 outside the majority of the volume occupied by the power source 532.

The device 502 may further include a circuit board 554 that may include conductive elements. In one embodiment, the antenna 534 may be situated away from the circuit board 554. For example, in one embodiment printed circuit board 554 may be positioned below the power source 532 to optimize the distance between its conductive elements and the antenna 534. It is understood that terms such as below and top are relative, and that here, below indicates a position closer to the earmount. To substantially optimize antenna performance, it may be beneficial to situate the antenna 534 a substantial distance from the conductive elements of the circuit board 554. The position of the antenna 534 is furthermore, close to the top of the device 502 with additional antenna elements 536 that may be situated at a far end of housing portion 510 away from the housing portion 508 including the power source 532. In this way, conductive elements, for example, of the printed circuit board 554 of the device 502 may be positioned away from the direction of the electromagnetic energy of the antenna 534.

In one embodiment, circuit board 554 may be supported by the housing. The circuit board may have a length 555 and a width 557, the length 555 defining a first portion 559 of the circuit board having a first size and a second portion 561 of the circuit board having a second size. The power source 532 may be positioned adjacent the first portion 559 the circuit board 554, and may occupy a volume adjacent the first portion 559 of the circuit board 554. The first size of the first portion 559 of the circuit board 554 may be approximately equal to the second size of the second portion 561 of the circuit board 554.

While FIG. 5 illustrates that the power source 532 is situated proximal the circuit board 554, it may be beneficial to position the power source 532 close to the bottom of the housing 504 for the benefit of weight distribution of the power source 532. In another embodiment, the antenna 534 is positioned within a volume adjacent the second portion 561 of the circuit board 554. In yet another embodiment, antenna 534 may be positioned within the second portion 510 of the housing 504.

It is understood that devices illustrated in the figures are not necessarily proportional. For example, a printed circuit board 554 may be approximately 0.8 mm thick and the power source 532 may be approximately 12 mm thick, and the entire device 502 may be approximately 13-14 mm. As discussed above, there is a trend toward smaller mobile communication devices. As mobile communication device technology has continued to improve, the components have become increasingly smaller. It is understood that the components and their relative positions may facilitate a more effective weight distribution and/or control of the antenna signal output as size of components decreases. Accordingly, the printed circuit board 554 may be small enough so that it need not straddle volumes 508 and 510 and the power source 532 may be able to be situated closer to the bottom area of the interior volume of the housing 504 which may provide better balance of the device 502 when positioned on an ear of a user. In any event, situating the antenna 534 distal the conductive elements and in particular those of the printed circuit board 554 may be beneficial.

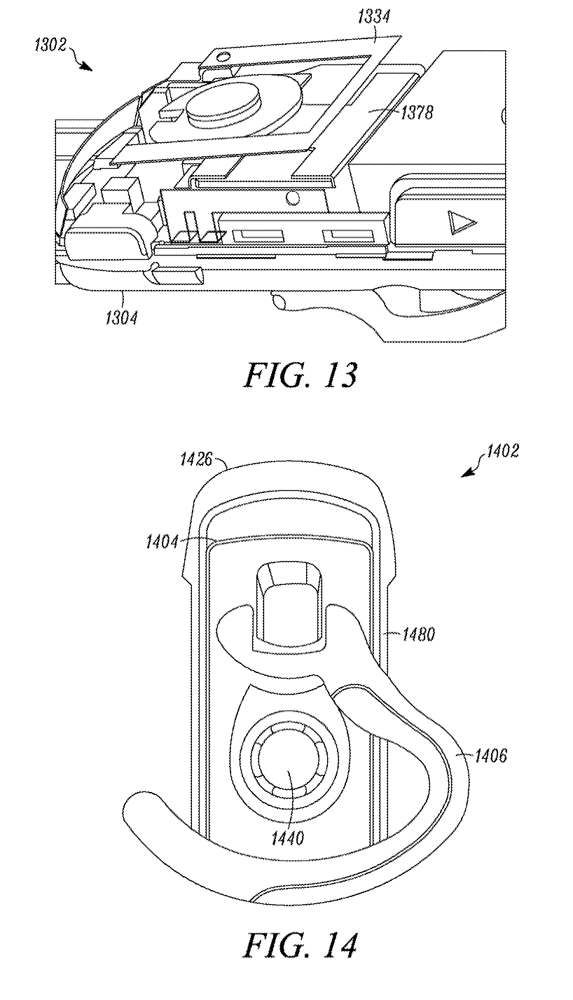

Looking ahead momentarily to FIG. 13, a SIM card holder 1378 may be positioned within the device 502. The SIM card holder 1378 position may be chosen to maximize board space by elevating it above the board closer to the antenna element and more easily accessible from the side. The close proximity of the SIM card and its shroud around to the antenna may be advantageous. The SIM and its metal shroud around may for example be used to tune for antenna bands, that is, shorting the metal shroud may be used to tune for different bands—GSM, DCS, and so on. The shroud carrying the SIM may be shaped and switched for antenna tuning, for example, having short endpieces, referred to below as “goalposts,” and a flat midpoint region.

FIG. 6 depicts an embodiment of a wearable cellular device 602 where the label on the housing 604 is removed, revealing an antenna element 634. By situating the antenna 534 very close to the top of the device 604, it may be possible to reduce the overall size of the device as well as keep the conductive elements of the printed circuit board 554 (see FIG. 5) distal the antenna 634. The antenna may be thin, and/or broad, so that the thickness of the device 502 as a whole may be minimized.

As mentioned, when using a handheld device, a user's hand will cover the device as it is held up to the user's head, so the amount of power used to drive the cellular antenna must compensate for the fact that a hand is covering the antenna. It may be beneficial that in an embodiment of an earmounted device such as 602, the power used to drive the cellular antenna 634 may be less than that used to drive a cellular antenna of a handheld device in that a user will most likely not put his or her hand over the device since it may be relatively securely positioned over the user's ear by the earmount 606 arrangement as described in detail above. Less power used to drive the antenna 634 may provide that there is less wave energy propagated in a direction toward or near the user's head, and possibly better utilization of power source 532 (see FIG. 5) resources.

Moreover, the configuration and the situation of the antenna 634 that of course may be a combination of antenna components may provide that the wave energy may be propagated primarily in a direction about the power source, as described in more detail below.

A sensor to detect when the device is mounted on a user's ear may be used to activate and deactivate one or more features of the device 602. If a sensor were to detect that the device is not positioned on the user's ear, the device 602 may increase the power to the antenna since it may be likely held in a user's hand. Or, in the event that there was a reduced signal strength, the device may compensate for the reduced signal strength, once the device is removed from the user's head, by increasing the power to the cellular antenna 634.

FIG. 7 depicts an embodiment of a wearable cellular device 702 where the top cover of the housing 604 (see FIG. 6) is removed. The position, configuration and/or situation of the antenna 734 may provide that the wave energy of the antenna 734 is propagated primarily in a direction about the power source 732. In another embodiment, the antenna 734 is configured to propagate wave energy in a direction different than toward the power source 732. In another embodiment, the antenna 734 is configured to propagate wave energy in a direction away from the power source 732. In another embodiment, the antenna 734 is configured to propagate wave energy so as to avoid the volume of the power source 732. A plurality of arrows 760, 761, 762, 763, 764, 765, and 766 illustrate a direction, or the directions of wave propagation by the antenna 734, and/or antenna components. Antenna components that may include 734 and antenna front bar 735 that may propagate wave energy. The front bar 735 may be in any suitable location. It may be less important that the front bar 735 be distal conductive elements of the device 702. The feed 758 may connect the front bar 735 with a larger antenna component 734 including a thin bar 759. The thin bar 759 may be thin enough to avoid any substantial propagation of wave energy near the power source 732. In this way, the amount of wave energy that is propagated in the direction of the power source 732 may be limited. It is understood that any situation, position and/or configuration of the antenna that may provide that the wave energy of the antenna 734 is propagated primarily in a direction about the power source 732 is within the scope of this discussion.

The antenna 734 may employ folded inverted conformal antenna (FICA) technology. As used herein, the antenna 734 may emit signals according to two modes, a parallel plate mode and a dipole mode. In general, a third mode, loop mode, may be possible, but is not used in the described embodiment. Emissions in a low frequency band may be according to a parallel plate mode with fields contained between an antenna element for example 734 and the printed circuit board 554 (see FIG. 5). Emissions in a high frequency band may be according to a dipole mode, having fields between left and right of the elements (between the “goalposts”) of the SIM card holder 1378 (see FIG. 13) which may be electrically coupled to the antenna element 734.

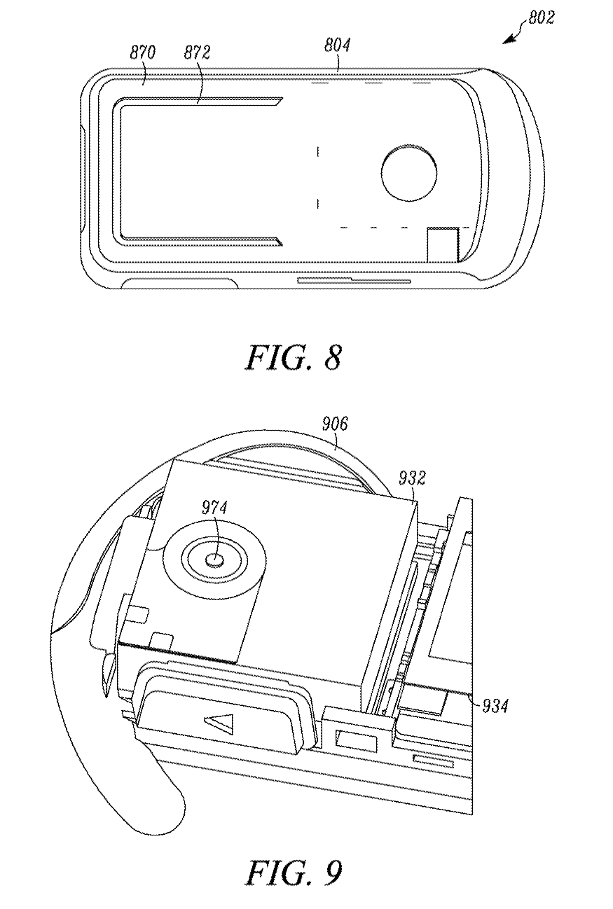

FIG. 8 depicts an embodiment of a user interface (UI) on the top side 870 of the housing 804 of the wearable wireless communication device 802. There may be a patterned cutout speech recognition button or sensing area 872 in communication with speech recognition circuitry 450 (see FIG. 4). In such an embodiment, speech recognition control circuitry 450 may be included. As discussed above, as mobile communication device technology has continued to improve, the devices have become increasingly smaller. Therefore, there may less surface area for placement of user interface components such as displays as manufacturers continue to add features and reduce their products' size. In a wearable cellular communication device 102 (see FIG. 1), a UI may avoid the use of a display screen and/or a keypad, although in another embodiment either or both a display screen and/or a keypad may be included.

As mentioned, the top side 870 of the housing 804 may include any type of speech recognition activation device. In the embodiment of FIG. 8, pressure by for example a hand of the user over the area of the speech recognition sensing area 872 may activate a button below the surface of the top side 870. The actuation area is depicted as fairly large so that a user may press over a large surface area to activate the button so that no raised bump or ridge may be required to indicate the button location. In this way, a user touching a portion of the sensing area 872 may activate the speech recognition circuit 450 (see FIG. 4).

FIG. 9 illustrates an embodiment of a button contact 974 that may be activated when the user depresses the sensing area 872 as illustrated in FIG. 8. The button 974 may be of a button contact type similar to those of existing keypads or any other suitable button including metal dome over flexible circuit board or any other suitable configuration. When a user presses the housing at sensing area 872, the button 974 may be compressed and an electrical circuit may be completed to activate the speech recognition circuitry 450 (see FIG. 4). While the discussion immediately above is with reference to speech recognition circuitry 974, it is understood that the disclosed sensing area may be of any type such as capacitive or resistive, and it may activate any function of the device, including any UI device.

A speech recognition module 451 (see FIG. 4) may provide instructions to implement a UI involving speech recognition. As previously discussed, the disclosed modules disclosed can carry out certain processes of the methods as described. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

The user interface (UI) of the wearable cellular communication device may include any number of functions. In one embodiment a microphone 442 and a speaker 440 (see FIG. 4) may be provided both for communication purposes and for speech recognition purposes. In the event that the device does or does not include, for example, a standard keypad, speech recognition that may operate through speech recognition circuitry 450 and/or a speech recognition module 451 may be provided as a UI.

The speaker 440 and the microphone 442 (see FIG. 4) may be situated on the housing 202 (see FIG. 2). In another embodiment, a microphone may be supported or mounted on a retractable boom supported by the housing 204. Since the device may be of a small size, a boom, for example, a retractable boom, may bring a microphone closer to the user's mouth. Alternatively, a sensitive microphone 442 may be mounted on the housing 202.

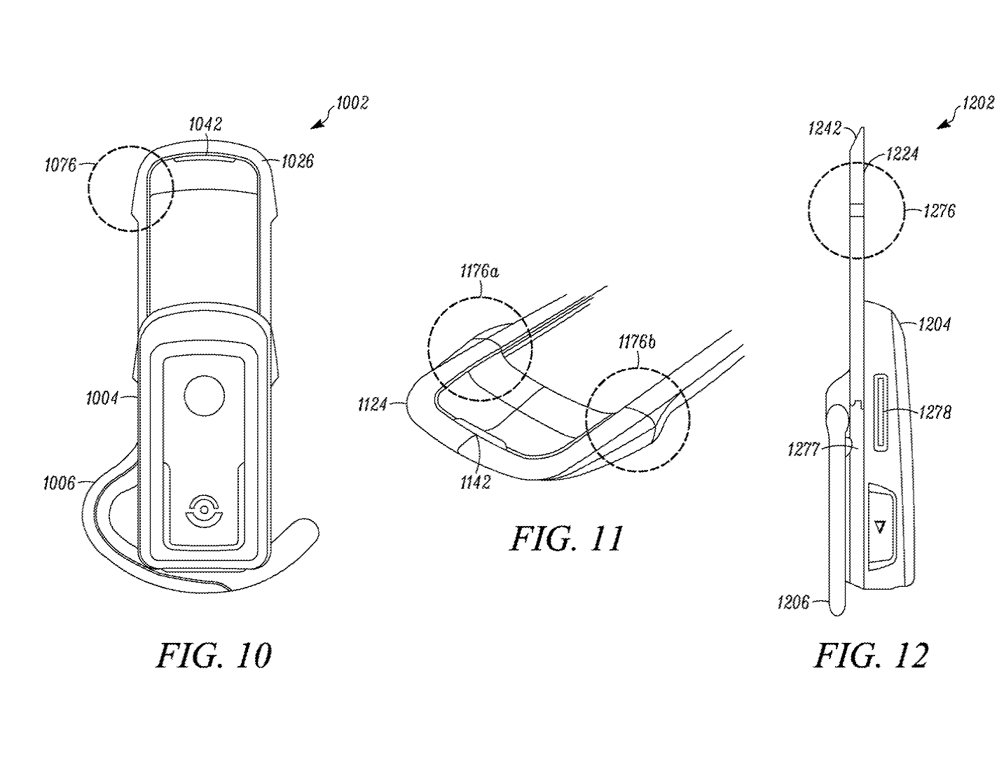

FIG. 10 depicts an embodiment of a microphone boom 1024 including a microphone 1042. In one embodiment, a retractable boom 1024 may extend a predetermined distance to minimize path loss. For example, a 40 mm boom may have a path loss that is several decibels (dB) less than a 20 mm boom. In another embodiment, a boom 1024 may be, for example, a flexible tube that may be moved away from the housing 1004 or toward the housing 1004. The microphone 1042 may be used to provide user input to a speech recognition based UI 450 (see FIG. 4). A speech recognition module 451 may provide instructions to implement a UI involving speech recognition. The depicted embodiment of a microphone boom 1024 may include a region 1076 that may be used by the user to grip the retractable boom 1024 to pull it away from the housing 1004.

FIG. 11 depicts a perspective view of the microphone boom 1124 including microphone 1142. Two regions 1176a and 1176b are depicted to show a protruded surface so that the user may easily pull the retractable boom 1124 away from the housing 1004 (see FIG. 10). The regions 1176a and 1176b may include contours that facilitate a user pushing the retractable boom 1124 toward the housing 1004.

FIG. 12 depicts a side view of the retractable boom 1224 as it may be positioned on a housing 1204. The track 1277 for the retractable boom 1224 on the housing 1204 may provide friction so that the boom may be pulled out less than all of the way and may maintain such a position. Also, the track 1277 and retractable boom 1224 combination may provide for a stopping mechanism at one or more positions along the track 1277. It is understood that any type of boom, including a retractable boom 1224 is within the scope of this discussion.

As mentioned, a microphone 1242 may be in communication with a controller 436 (see FIG. 4) of the device 1202. The controller 436 may in turn be in communication with one or more transceivers 426, and in particular, a transceiver 426 for cellular communication. The speaker 440 may also be in communication with the controller 436.

FIG. 13 depicts a metal top of a SIM card connector 1378 that may be used as part of the antenna 1334 tuning system. For cellular communications, user identification provided by a SIM card may be introduced into the device 1202 (see FIG. 12) by a SIM card slot 1278. It is understood that a SIM card slot 1278 may be situated in any suitable location.

Antenna components that emit energy in a low frequency communication band may be highly coupled to the printed circuit board (PCB) 554 (see FIG. 5). It may be desirable to functionally isolate antenna components that emit energy in a high frequency band, for example, at the tips/goalposts of the SIM card connector 1378. It may further be desirable to couple antenna components that emit energy in a high frequency band to couple to the PCB 554 at the midpoint of the SIM card connector 1378. The midpoint coupling may be employed advantageously to use the SIM shroud for tuning an antenna configuration or conformation for more than one frequency band.

FIG. 14 depicts an embodiment of a bottom side of the housing 1404. The speaker 1440 may be positioned near the earmount 1406. The retractable boom 1426, in this depiction is in its retracted position. The speaker 1440 may be used for voice communication. However, it may be beneficial to provide a different mode of an incoming call alert than a ring tone generated from the speaker 1440, since the speaker 1440 may be situated against the user's ear when the device 1402 is worn. If a user chooses an audible alert, its volume may be gradually increased. A vibrator motor 1480 may be positioned in any position on the housing 1404 or earmount 1406 to act either in place of a ringtone, or in addition to a ringtone to alert the user of an incoming call. A vibration generated from the vibrator motor 1480 may avoid a ringtone that could disturb others in the vicinity of the user. Moreover, a vibration generated from the vibrator motor 1480 may be positioned in a touch sensitive position adjacent the user's head, to optimize the vibrations felt from the vibrations generated from the vibration motor 1480.

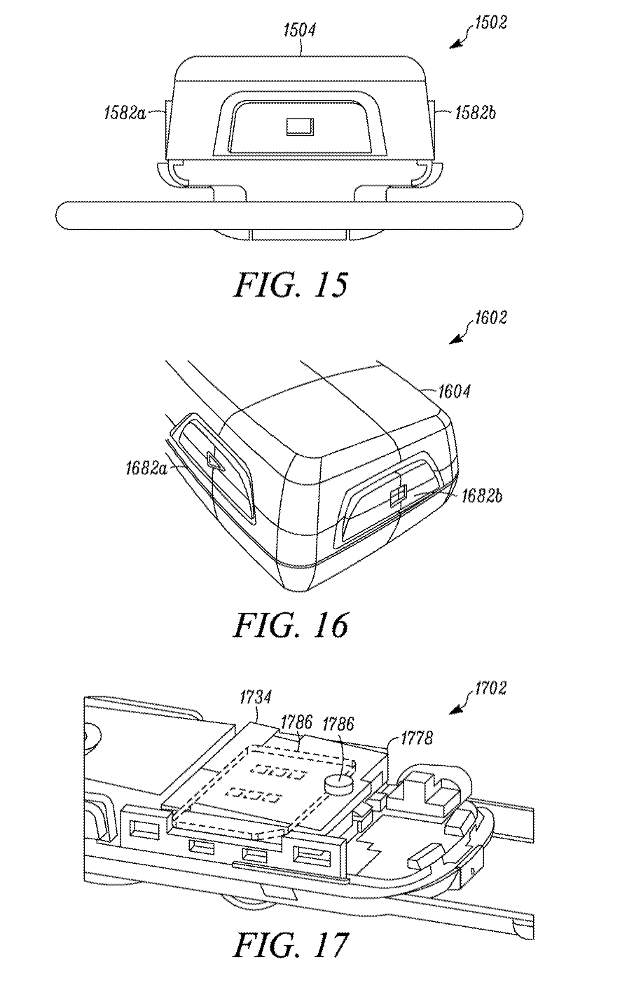

FIG. 15 depicts an end view of a device 1502. Due to the limited surface space of the housing 1504, UI input may be limited to a few buttons, in particular, one or more buttons 1582a, 1582b. In the event that the speech recognition UI in accordance with speech recognition module 451 (see FIG. 4) is impaired, for example by ambient noise, or a desire for privacy by the user, a supplemental UI may be beneficial. A supplemental UI may be provided by supplemental UI circuitry 482 (see FIG. 4) and/or a supplemental UI module 483. As mentioned, it may not be feasible to include, for example, a standard keypad. In the event that any keypad (not shown) was available on the device 1502, then the user may need to remove the device 1502 from his or her ear to use the keypad. Alternatively, it is understood an embodiment with a keypad that is easy to navigate without visual contact is within the scope of this discussion.

FIG. 16 depicts a perspective view of a device 1602. Due to the limited surface space of the housing 1604, UI input may be limited to a few buttons, in particular, for example, buttons 1682a and 1682b. Different tapping strategies, as explained below, may be provided for UI input. The buttons 1682a and 1682b may represent standard buttons. Also, or alternatively, one or more touch sensitive strips may be included for gestural user input.

As mentioned, different tapping strategies for a supplemental UI may be provided in connection with device 1602. A user interface for controlling basic functionality of an earmounted cellular device 1602 such as, take/reject a call, dial a number, and/or adjust volume, may include on the side of an ear- or head-worn cellular communication device 1602, a sensor 1682a, 1628b or another sensor which can detect finger tap events. The sensor, for example 1682a may be able to differentiate between a tap with a single finger and a tap with two fingers. Furthermore, the sensor, for example 1682a may be able detect a finger slide event and its direction. The sensor for example 1682a may also be able to detect tap-and-hold events as well as double-tap events.

Functionality may include answering an incoming call, for which a user may tap with single finger. To reject an incoming call or terminate an ongoing call, a user may tap with two fingers. To initiate number dialing via speech recognition, a user may tap with single finger. To initiate phone number entry, user may double tap with a single finger. After a short beep, a prompt may start reading numbers from 0 to 9. Once the prompt reaches the first digit of the phone number, a user may tap to select the number. The above described procedure may be repeated for all digits of the phone number. Once entry is complete, a voice prompt may repeat the number back to the user. If the number has been entered correctly, a user may single tap to start the phone call.

In another implementation of digit entry, after a short beep a user may tap and hold. A prompt may start reading digits from 0 to 9. Once the desired number is announced, a user may release his or her finger to select it. Another implementation of number entry may include after a short beep, to enter a digit n>0, a user may tap n times. To enter number 0, a user may not tap at all until a timeout period is reached.

To retrieve various status information such as remaining battery life, and account information, a user may tap and hold until a speech synthesizer starts reading the requested status information. To increase volume during an ongoing call, a user may slide his or her finger in an up or down direction. To decrease volume during an ongoing call, a user may slide his or her finger in a down-up direction.

FIG. 17 is a cutaway view of the device 1702 depicting an arrangement for a SIM card holder 1778 that may incorporate UI components such as an indicator light. The holder 1778 may be made of plastic and may include an antenna tuning patch 1734. The SIM card holder 1778 may also incorporate a light pipe for illumination, for example, of an indicator light 1786. An indicator light module 486 (see FIG. 4), for example, may drive the indicator lights.

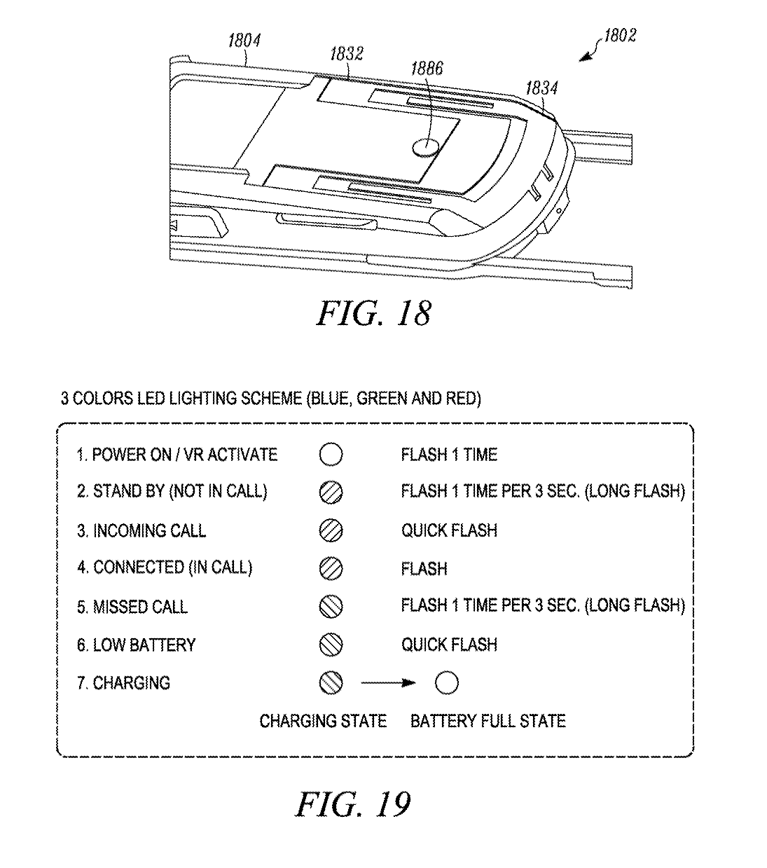

FIG. 18 depicts an embodiment of a device 1802 having the top portion of the housing 1804 removed to expose an embodiment of an antenna configuration 1834. An indicator light 1886 is depicted. It is understood that the indicator light 1886 may be in any position on the housing 1804 or on the earmount 106 (see FIG. 1). Moreover, it is understood that any number of indicator lights 1886 may be incorporated.

An indicator lighting scheme may provide an indication to a user of the state and/or status of functions and/or condition of the device 1802. It is understood that any functions may be incorporated into the device 1802 as described in the non-all-inclusive list provided above. Therefore, the state and/or status of the device 1802 may be indicated by indicator lights and/or speech synthesizes by the device.

FIG. 19 depicts an embodiment of an indicator light scheme. A three color LED lighting scheme, including for example, blue, green and red, may be provided. Items 1-7 in the lighting scheme illustrate the certain state and/or status indications, including, for example, flash one time for power on/speech recognition activation; flash one time per three seconds that may be for example a long flash for stand-by mode; a quick flash for an incoming call; a flash for the device in a connected state; flash one time per three seconds for a missed call; a quick flash for a low battery; and one color or another for a charging state and a battery full state for charging indication. It may be beneficial to discontinue the light indicators when the device is positioned on a user's head to save power resources. A sensor may be positioned in a suitable position to determine whether the device is positioned on the user's head.

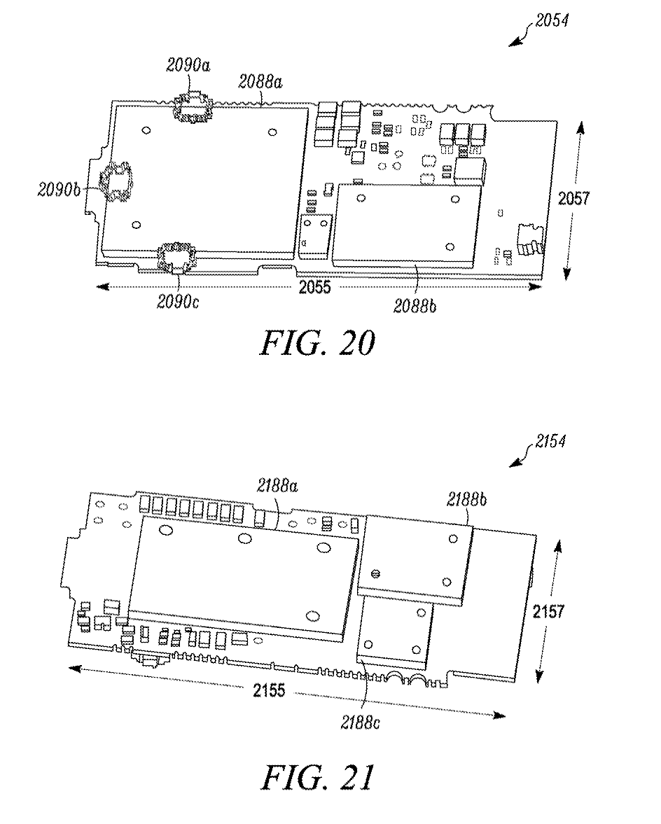

FIG. 20 is an embodiment of the top of a printed circuit board 2054 that may include shielding 2088a and 2088b. The circuit board 2054 configuration may be designed to allow various peripherals to be in communication with the device 702 (see FIG. 7). Depending upon the processes made available and the configuration of the printed circuit board the shielding may be appropriately placed to avoid coupling to the antenna 734. The region defined by the width 2057 of the printed circuit board 2054 proximal the antenna bar 735 may have limited or no metal or otherwise conductive components that is not part of the antenna 734 circuitry to avoid coupling to the antenna 734.

FIG. 21 is an embodiment of the bottom of a printed circuit board 2154 that may include shielding 2188a, 2188b and 2188c. As mentioned above, depending upon the processes made available and the configuration of the printed circuit board the shielding may be appropriately placed. The region defined by the width 2157 of the printed circuit board 2154 proximal the antenna bar 735 (see FIG. 7) may have limited or no metal or otherwise conductive components that is not part of the antenna 734 circuitry to avoid coupling.

Returning to FIG. 20, there are illustrated cutouts 2090a, 2090b and 2090c. Certain components of the printed circuit board 2054 may include board mounted switches. The cutouts may be places so that a switch plunger can be accessed. It is understood that the cutouts 2090a, 2090b and 2090c may be situated in any suitable position and that there may be any number of them as required. Moreover, those illustrated or others may be used for connections such as a battery charger port and peripherals ports.

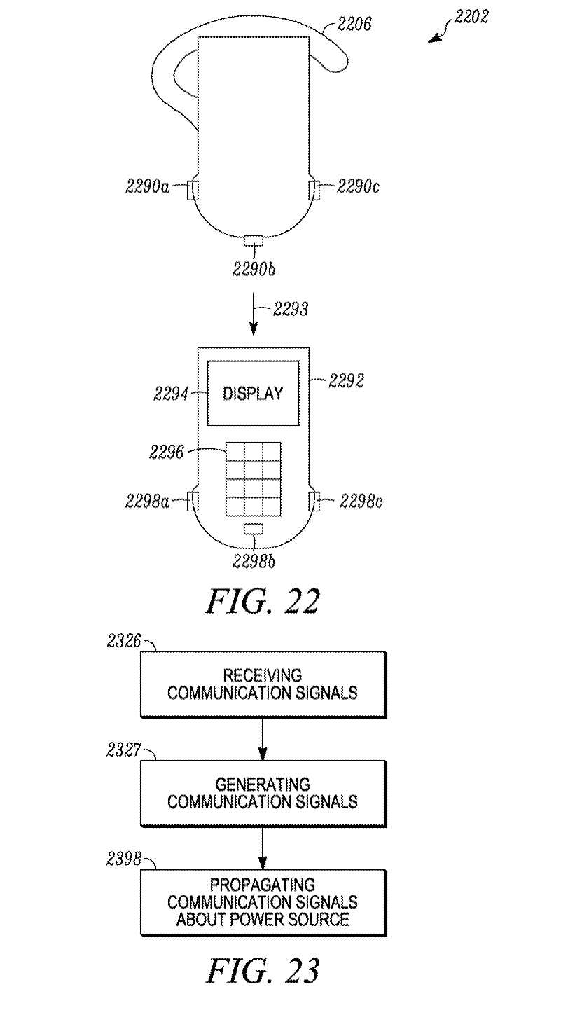

FIG. 22 depicts an earmounted cellular telephone device 2202 and a handset form factor frame 2292 peripheral. As mentioned above, an earmount 2206 may be detachable from the device 2202. In the event that a user would wish to use the earmounted cellular telephone device 2202 as if it were a handset device, the earmount 2206 may be detached, and the device 2202 may be slid into a handset form factor frame 2292, for example in direction 2293. The frame 2292 may include, for example a display screen 2294 and a standard keypad 2296. The frame 2292 may provide any type of hand held form factor such as a candy bar form factor, a slider form factor, a rotator form factor, or a flip phone form factor.

Above, it was mentioned that cutouts 2090a, 2090b and 2090c (see FIG. 20) may be used for connections such as peripherals ports. For example, connectors 2290a, 2290b and 2290b may be used to connect the earmounted device 2202 to the handset form factor frame 2292 at connectors 2298a, 2298b and 2298c that may be on the interior of the frame 2292. When the device is positioned within the frame 2292, the power to the antenna 534 (see FIG. 5) may be increased, as discussed above, since a user's hand may cover the antenna, decreasing its effectiveness.

The frame 2292 may incorporate any number of characteristics to make it compatible with the earmounted device 2202. For example, audio pipes may be routed for audio coupling to bring voice communications from a user to the microphone 1042 (see FIG. 10). Moreover, a speaker audio pipe may be aligned with the earmounted device 2202. It is understood that any type of functionality may be incorporated into the earmounted device 2202 as well as that of the frame 2292.

As discussed in detail above, in an ear mounted cellular device 102 (see FIG. 1), there may be a limited volume in which to position a cellular antenna 534 (see FIG. 5). The size and in particular the disclosed arrangements and configurations of components of the ear mounted cellular telephone device 102 may allow a cellular device to have a configuration similar to that of a Bluetooth headset while supporting a cellular antenna 534. In this way, a user may have the hands-free benefit of a headset without the inconvenience of pairing the devices and the inconvenience of operating two devices simultaneously.

Disclosed is a wireless communication device 102 (see FIG. 1) including a housing 104 and an earmount 106 attached to the housing. A wireless transceiver 426 (see FIG. 4) is supported by the housing 104, the wireless transceiver being configured to communication with a cellular base station 430. A power source 432 may be coupled to the wireless transceiver and supported by the housing, the power source having sufficient energy to power the wireless transceiver for communication 428 with the cellular base station. The earmount 106 may be attached to the housing 104 and disposed at a position such as within housing portion 108 and at a portion proximal the power source. An antenna may be coupled to the wireless transceiver supported by the housing, the antenna being configured to propagate wave energy primarily in a direction about the power source.

FIG. 23 is a flow chart depicting a method 2325 of the above-described earmounted cellular telephone device that may receive communication signals 2326 via a cellular transceiver 426 (see FIG. 4) and transmit communication signals 2327 via a cellular transceiver 426. The method may include propagating communication signals 2398 via an antenna 434 about the power source 432. The method may include propagating wave energy 760, 761, 762, 763, 764, 765 and 766 (see FIG. 7) in a direction different than toward the power source 732. In this manner, the method may include propagating wave energy 760, 761, 762, 763, 764, 765 and 766 in a direction away from the power source 732. Accordingly, the method may include propagating wave energy 760, 761, 762, 763, 764, 765 and 766 so as to avoid the volume of the power source.

The disclosed wireless communication device may be capable of being positioned in a wearable position adjacent a user's head. The disclosed wireless communication device such as a cellular telephone or a headset is an over-the-ear device that can be convenient to use. The overhanging portion of the earmount may be stable, even when touched by the user because of the manner it which it may hang down from the ear from which it is balanced therefrom and the weight distribution based on the position of the power source with respect to the earmount.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A wireless communication device, comprising:
a housing;
a wireless transceiver supported by the housing, the wireless transceiver being configured to communicate with a cellular base station;
a power source coupled to the wireless transceiver supported by the housing, the power source having sufficient energy to power the wireless transceiver for communication with the cellular base station;
an antenna coupled to the wireless transceiver supported by the housing, the antenna being configured to propagate wave energy primarily in a direction about the power source; and
an earmount attached to the housing at a portion proximate to the power source.

2. The device of claim 1, further comprising a circuit board including a first portion having a first size and a second portion having a second size, and wherein the power source is positioned adjacent the first portion of the circuit board, and occupies a volume adjacent the first portion of the circuit board.

3. The device of claim 2, wherein the antenna is positioned within a volume adjacent the second portion of the circuit board.

4. The device of claim 1, wherein the housing includes a first portion having a first size and a second portion having a second size, and wherein the power source occupies a volume of the first portion of the housing.

5. The device of claim 1, wherein the antenna is positioned within the second portion of the housing.

6. The device of claim 1, wherein the housing includes a volume and wherein the power source occupies a majority of the volume of the housing.

7. The device of claim 6, wherein the antenna is positioned in a portion of the volume outside the majority of the volume occupied by the power source.

8. The device of claim 1, wherein the power source is positioned within a first portion of an internal volume of the housing, the power source having a weight sufficient to offset a majority of the torque forces of the device when the device is supported by the earmount.

9. The device of claim 8, wherein the antenna is positioned within a second portion of the internal volume.

10. The device of claim 1, wherein the power source is a low impedance battery capable of driving a cellular pulse of the wireless transceiver for communication with the cellular base station.

11. The device of claim 1, wherein the antenna is configured to propagate wave energy in a direction different than toward the power source.

12. The device of claim 1, wherein the antenna is configured to propagate wave energy in a direction away from the power source.

13. The device of claim 1, wherein the power source occupies a volume and wherein the antenna is configured to propagate wave energy so as to avoid the volume of the power source.

14. A method of a wireless communication device including a housing, a wireless transceiver supported by the housing, the wireless transceiver being configured to communicate with a cellular base station, a power source coupled to the wireless transceiver supported by the housing, the power source having sufficient energy to power the wireless transceiver for communication with the cellular base station, an antenna coupled to the wireless transceiver supported by the housing, and an earmount attached to the housing at a portion proximate to the power source, the method comprising:
receiving communication signals from the base station by the transceiver;
generating communication signals to the base station by the transceiver; and
propagating wave energy by the antenna primarily in a direction about the power source to transmit the communication signals.

15. The method of claim 14, wherein propagating wave energy by the antenna comprises:
propagating wave energy in a direction different than toward the power source.

16. The method of claim 14, wherein propagating wave energy by the antenna comprises:
propagating wave energy in a direction away from the power source.

17. The method of claim 14, wherein propagating wave energy by the antenna comprises:
propagating wave energy so as to avoid the volume of the power source.

18. A wireless communication device, comprising:
a housing, wherein the housing has a length and a width, the length defining a first portion of the housing having a first size and a second portion of the housing having a second size;
a wireless transceiver supported by the housing, the wireless transceiver being configured to communicate with a cellular base station;
a power source coupled to the wireless transceiver supported by the housing, the power source having sufficient energy to power the wireless transceiver for communication with the cellular base station, wherein the power source occupies a volume of the first portion of the housing, wherein the first size of the first portion is approximately equal to the second size of the second portion;
an antenna coupled to the wireless transceiver supported by the housing, the antenna being configured to propagate wave energy primarily in a direction about the power source; and
an earmount attached to the housing at a portion proximate to the power source.

19. The device of claim 18 wherein the power source has a weight sufficient to offset a majority of the torque forces of the device when the device is supported by the earmount.
